(19) United States
(12) Patent Application Publication
(10) Pub. No.: US 2026/0288752 A1
(43) Pub. Date: Sep. 24, 2026

(54) AUTONOMOUS GENERATION OF AN INTERACTIVE DATA VISUALIZATION DASHBOARD

(71) Applicant: UnitedHealth Group Incorporated, Minnetonka, MN (US)

(72) Inventors: Sahukari Kranthi Kiran Chowdhary, Tamilnadu (IN); Venkateswara R. Kakula, Cumming, GA (US); Praveen K. Modukuri, Telangana (IN); Thatha Pavan Kumar, Bangalore (IN)

(21) Appl. No.: 19/082,773

(22) Filed: Mar. 18, 2025

(51) Int. Cl. G06F 16/26; G06F 9/451; G06F 16/21

(52) U.S. Cl. CPC G06F 16/26; G06F 9/451; G06F 16/212

(57) ABSTRACT

Techniques for autonomously generating of an interactive data visualization dashboard are provided. The techniques may generate a data insights matrix for a dataset that specifies features of the dataset according to the preconfigured set of data context attributes, and input the data insights matrix to a domain identification machine-learned model to generate a domain identifier for the dataset. The techniques may use the domain identifier, along with a user-provided data visualization intent and the data insights matrix, to generate a particular data visualization dashboard from among different options.

### TECHNICAL FIELD

The present disclosure generally relates to visual representations for large datasets, and more particularly, to techniques for autonomous generation of an interactive data visualization dashboard.

### BACKGROUND

In many fields, there is a need to provide visual representations of large datasets in a manner that facilitates a quicker and/or more comprehensive understanding of the information that the datasets represent. In healthcare, for example, the advent of electronic medical records and electronic documentation generally has enabled compilation of large patient and group data that can be analyzed visually to gather important insights. Furthermore, because of the large number of possible data visualizations a user could be interested in viewing it can be advantageous to generate visual data representations in an on-demand environment. However, current techniques are not very effective at efficiently generating visual data representation in an on-demand environment as they tend to rely on general, one-size-fits-all coding and/or programming expertise by the user.

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates a same or similar item.

FIG. 1A depicts an example computing environment in which various embodiments of the present disclosure can be implemented.

FIG. 1B depicts an example interactive data visualization dashboard selection process.

FIG. 2 depicts an example dataset modification process.

FIGS. 3 and 4 depict an example data insights matrix generation process.

FIG. 5 depicts an example domain detection process.

FIG. 6 depicts another example interactive data visualization dashboard selection process that incorporates a dashboard selection machine-learned model.

FIGS. 7 and 8 different user interface screens for initiating display of an interactive data visualization dashboard.

FIG. 9 depicts an example interactive data visualization dashboard.

FIG. 10 depicts a flow diagram of an example computer-implemented method for selecting an interactive data visualization dashboard.

### DETAILED DESCRIPTION

The techniques described herein relate generally to generating and deploying an interactive data visualization dashboard that provides graphical visualizations of a dataset according to one or more user-defined data visualization intents (e.g., preferences) for the dataset. To that end, the techniques described herein employ a domain detection machine-learned (ML) model to determine a domain of the data set based at least on a data insights matrix that is constructed by analyzing sampled portions of the dataset relative to a preconfigured set of data context attributes. Using the data insights matrix as an input to the ML model provides several technical improvements. For example, employing ML models (e.g., classifiers) for raw/direct data analysis (e.g., using the entire dataset as an input) requires using ML models with very large context windows, which may not be feasible or efficient. Using a data insights matrix according to the principles described herein can improve performance by enabling use of a smaller context window. A smaller context window ML model can reduce the amount of processing resources needed to run the ML model, because the context window size is a function of the number of trained parameters and layers included within the ML model, with more parameters and layers generally requiring more processing resources to execute the ML model. Furthermore, ML models with smaller context windows are easier to tune and train because of the generally smaller amount of parameters employed by these models. This in turn allows the techniques of the present disclosure to facilitate the creation of custom-fit ML models tuned or trained for specific use cases (e.g., specific domains of data).

In some embodiments, the techniques described herein also modify the organizational schema of the input dataset according to a domain dictionary for use by the system and, in particular, for ingestions by the various ML models described herein. The modified dataset may be used in conjunction with the data insights matrix by various ML models described herein. For example, both the modified dataset and the data insights matrix may be input to the domain detection ML model. The relevant domain determination may be used to assist in selecting a interactive data visualization dashboard by acting as an input to a dashboard selection ML model or as a filter on dashboard options from which the dashboard selection ML model can make a selection. Using the modified dataset as an ML model input does impose the trade off described above with respect to processing resources and context window size. However, modifying the organizational schema of the input dataset still provides technical improvements in terms of tuning and training resources. In particular, revising the organizational schema based on the domain dictionary forces the datasets that are processed through the ML models described herein to conform to predefined structures. The ML models can be trained or tuned to process, recognize, and/or analyze the datasets that are organized in these predefined structures with fewer training or tuning operations. Furthermore, the additional processing resources needed to modify the dataset schema are more than made up for by the processing savings from the reduced tuning and training operations given the large number of parameters and layers present in the ML models.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, the techniques described herein may be readily applied in any suitable field for any suitable purpose.

### Example Computing Environment

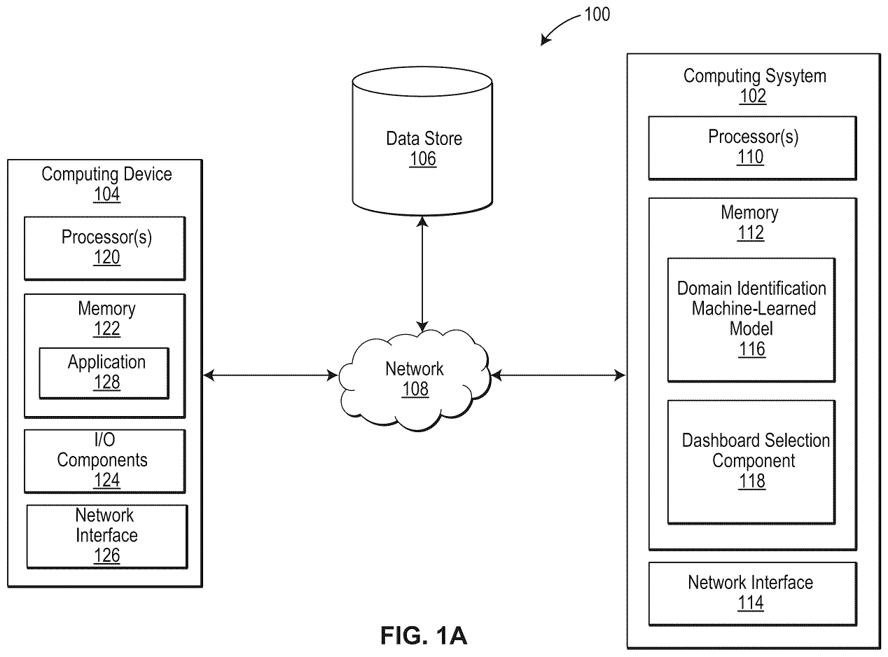

FIG. 1A depicts an example computing environment 100 in which various embodiments of the present disclosure may be implemented. Generally, the example computing environment 100 includes a computing system 102, a computing device 104, and a data store 106, some or all of which are communicatively coupled via a network 108.

Generally, the computing device 104 is associated with a user who may be seeking to deploy an interactive data visualization dashboard managed by (or otherwise associated with) the computing system 102. The computing system 102 may be associated with an organization that provides data visualization services including different potential interactive visualization dashboards.

The computing system 102 may include a single server, or multiple servers that are co-located and/or remotely distributed, for example. In some embodiments, the computing system 102 provides data visualization services via a cloud platform (e.g., Amazon Web Services (AWS)®, Microsoft Azure®, or Google Cloud®). The computing system 102 includes one or more processors 110, memory 112, and a network interface 114.

The processor(s) 110 may include any suitable number of processors and/or processor types. In some examples, the processor(s) 110 include one or more central processing units (CPUs), one or more graphics processing units (GPUs), one or more tensor processing units (TPUs), one or more field-programmable gate arrays (FPGAs), one or more application-specific integrated circuits (ASICs), and/or the like. Generally, the processor(s) 110 comprise hardware configured to execute instructions (e.g., processor-executable code/instructions) stored in the memory 112.

The memory 112 may include any suitable memory type(s), including one or more volatile memories (e.g., dynamic and/or static random-access memory (RAM)) and/or non-volatile memories (e.g., read-only memory (ROM), erasable programmable ROM (EPROM), electrically EROM (EEROM), NAND flash, and/or solid state drive(s) (SSD(s))), all or any of which are examples of non-transitory computer-readable media. In some examples, the memory 112 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 112 stores the processor-executable instructions of a domain identification machine-learned model 116 and a dashboard selection component 118.

In some embodiments, the memory 112 may store more, fewer, and/or different components, than what is depicted in FIG. 1A. In some embodiments, for example, some or all of the components that FIG. 1A shows as being stored in memory 112 are instead stored remotely, and are remotely accessed/used by the computing system 102. For example, the computing system 102 may remotely access the functionality of the domain identification machine-learned model 116 and the dashboard selection component 118 (or just access the domain identification machine-learned model 116, etc.) via a cloud service provided by another entity and computing system.

The network interface 114 includes one or more hardware and/or software components that are generally configured to enable the computing system 102 to communicate, via the network 108, with other components and/or devices of the computing environment 100, such as the computing device 104 and the data store 106. To this end, the network interface 114 includes hardware and/or software that operates in accordance with at least one communication protocol of the network 108.

The network 108 includes one or more wired and/or wireless communication networks, such as a cellular network (e.g., 5G®, 4G LTE®, 3G®), a Wi-Fi® network (i.e., an IEEE 802.11 standards network), a microwave access network (e.g., WiMAX®), and/or any other suitable wide area network (WAN), local area network (LAN), personal area network (PAN), etc. As just one example, the network 108 may include both a wireless LAN such as a Wi-Fi® network and a WAN such as the Internet. In some embodiments, the network 108 includes multiple, entirely distinct/parallel networks (e.g., one or more networks for communications between computing system 102 and computing device 104, and one or more separate networks for communications between computing system 102 and data store 106, etc.).

The computing device 104 may be a desktop computer, a laptop computer, a tablet device, a mobile device, a wearable device (e.g., augmented or virtual reality glasses/headsets), or any other suitable computing device. The computing device 104 includes one or more processors 120, memory 122, one or more input/output (I/O) components 124, and a network interface 126.

The processor(s) 120 may include any suitable number of processors and/or processor types. In some examples, the processor(s) 120 include one or more CPUs, one or more GPUs, one or more TPUs, one or more FPGAs, one or more ASICs, and/or the like. Generally, the processor(s) 120 comprise hardware configured to execute instructions (e.g., processor-executable code/instructions) stored in the memory 122. The memory 122 may include any suitable memory type(s), including one or more volatile memories (e.g., dynamic and/or static RAM) and/or non-volatile memories (e.g., ROM, EPROM, EEROM, NAND flash, and/or SSD(s)), all or any of which are examples of non-transitory computer-readable media. In some examples, the memory 122 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 122 stores the processor-executable instructions of an application 128, which may be, for example, a web browser application or a dedicated application (e.g., a data visualization application offered/provided by an entity associated with computing system 102).

The I/O component(s) 124 include hardware and/or software that generally enables a user of computing device 104 to interact with the computing device 104. The I/O component(s) 124 may include one or more input components that enable a user of computing device 104 to enter inputs to the computing device 104 (e.g., a keyboard, a microphone, etc.), one or more output components that enable the user to perceive outputs generated by the computing device 104 (e.g., a monitor/display, a speaker, a haptic feedback component, etc.), and/or one or more integrated I/O components (e.g., a touchscreen). The I/O component(s) 124 may use any suitable technology or technologies, such as LED, OLED, or LCD display technology, for example. While FIG. 1A shows computing device 104 as a single component communicating (via network 108) with the computing system 102, in some implementations the components of computing device 104 shown in FIG. 1A are instead divided among two or more client/user-side devices. As just one example, a pair of smart glasses may include one portion of the processor(s) 120, at least a portion of the memory 122, and a display of the I/O component(s) 124, while a smartphone may include another portion of the processor(s) 120, another portion of the memory 122, a touchscreen of the I/O component(s) 124, and the network interface 126. The smart glasses may then communicate as needed with the smartphone (e.g., via Bluetooth®) to enable the operations described herein.

The network interface 126 includes one or more hardware and/or software components that are generally configured to enable the computing device 104 to communicate, via the network 108, with other components and/or devices of the computing environment 100, such as the computing device 104. To this end, the network interface 126 includes hardware and/or software that operates in accordance with at least one communication protocol of the network 108.

The data store 106 may be implemented as a database, data lake, memory, or other digital storage medium known in the art. Accordingly, the data store 106 may be a file system data store, an object-based data store, or other type of data store utilized in the art. Depending on the embodiment, the data store 106 may be implemented locally at the computing system 102, externally at an external data storage service, or a combination thereof. The computing system 102, via the network interface 114, may be in wired or wireless communication with the external data storage service. As described in more detail below, the data store 106 may store data that the computing system 102 uses to select a data visualization dashboard that is provided to the computing device 104 for display via I/O components 124.

The domain identification machine-learned model 116 may comprise generative machine-learned model component(s), such as a transformer-based machine-learned model (e.g., a large-language model (LLM), an embedding model, a diffusion model, and/or the like), and may additionally or alternatively comprise other machine-learned model component(s), such as neural network(s), decision tree(s), and/or the like. In some examples, the domain identification machine-learned model 116 is trained to use text as input and to generate text or, in other embodiments, may be a multimodal LLM that operates upon and/or generates text and also other types of content (e.g., text, images, audio, etc.). The domain identification machine-learned model 116 may receive a text prompt (referred to herein at times as simply a “prompt”) as an input, process the text prompt, and output text content responsive to the text prompt. The domain identification machine-learned model 116 may additionally or alternatively include a deep neural network and may perform various natural language processing tasks to understand a text query/prompt and generate a response to the text query/prompt, e.g., as part of a pre-processing operation and/or a post-processing operation. For example, in a pre-processing operation a neural network and/or another transformer-based machine-learned model may be trained to augment the original prompt to add sufficient context, which may be based on processing inputs determined from user and/or provider query responses, subsequent user and/or provider feedback, and/or the like, that is determined to be associated with the prompt. In a post-processing operation, the neural network and/or another transformer-based machine-learned model may be trained to review and alter, as necessary, an output of the transformer-based machine-learned model to be suitable for use by the learning component dashboard selection component 118.

The domain identification machine-learned model 116 may have a transformer-based model architecture that comprises an encoder that tokenizes the input and determines embeddings for the tokens, and a decoder that generates the output based at least in part on the embeddings. The transformer model may incorporate self-attention and/or cross-attention mechanisms to facilitate more accurate output. In some embodiments, such a transformer-based machine-learned model may include different configurations of self-and/or cross-attention, followed by neural network(s) (e.g., feedforward layer(s)), recurrent layer(s), aggregation layer(s) (e.g., using softmax, matrix multiplication, and/or other aggregation techniques), and/or the like. The domain identification machine-learned model 116 may be a general-purpose model (e.g., trained on a wide array of publicly available datasets such as web pages, documents, etc., available via the Internet) such as a generative pre-trained transformer (GPT) 3.5, bi-directional encoder representations from transformers (BERT), or may be a domain-specific model (e.g., trained and/or fine-tuned on custom and/or proprietary datasets), such as a general purpose LLM trained using datasets of queries, responses, and user and/or provider feedback.

The functionality of dashboard selection component 118 and the operation of domain identification machine-learned model 116 are described in further detail below in connection with FIG. 1B, according to some embodiments.

### Example Data Visualization Dashboard Selection Processes

FIG. 1B depicts an first example operation of the computing system 102 and, in particular, the domain identification machine-learned model 116 and dashboard selection component 118 for selecting a data visualization dashboard to be presented on the computing device 104. For clarity, reference will also be made to the FIG. 1A and the components of the computing environment 100 throughout this section.

In operation, the computing system 102 may receive, via the network interface 114, a dataset 130 and a data visualization intent indication 131. The dataset 130 may be received from the computing device 104 or the data store 106. In some embodiments, the computing device 104 sends a location indicator of the dataset 130 within the data store 106 to the computing system 102 and the computing system 102 retrieves, via the processor(s) 110, the dataset 130 from the data store 106 using the location indicator. The computing system 102 may likewise receive the data visualization intent indication 131 from the computing device 104.

In general, the dataset 130 may include a raw unmodified grouping of data (e.g., a table, spreadsheet, csv, array, etc.) that the user of the computing device 104 wants to review on the computing device 104 using an interactive visualization dashboard that is managed by the computing system 102. The data visualization intent indication 131 may describe one or more types of data organization graphics, displays, summaries, representations, etc. that the user wishes to see within the interactive dashboard. In particular, the data visualization intent indication 131 may specify an initial representation of the dataset 130 that should be displayed when a first user interface of the interactive visualization dashboard is initially presented on the computing device 104 via a display device of the I/O component(s) 124. For example, the data visualization intent indication 131 may include freeform text input by a user that specifies the type of types of data organization graphics, displays, summaries, representations, etc. that the user wishes to see (e.g., “show me a graph of trends in X over time period Y”). Alternatively, the data visualization intent indication 131 may be an intent selected by a user from a predetermined list of different intents.

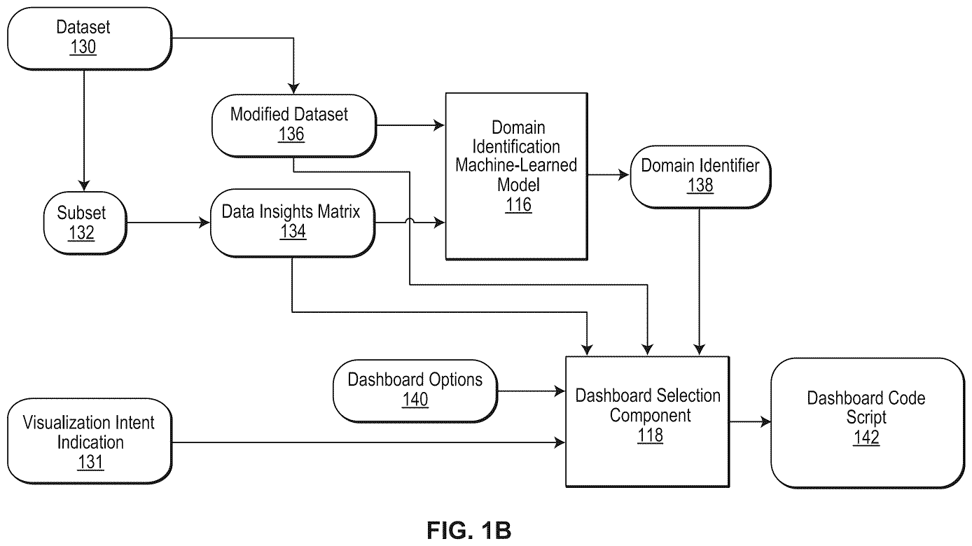

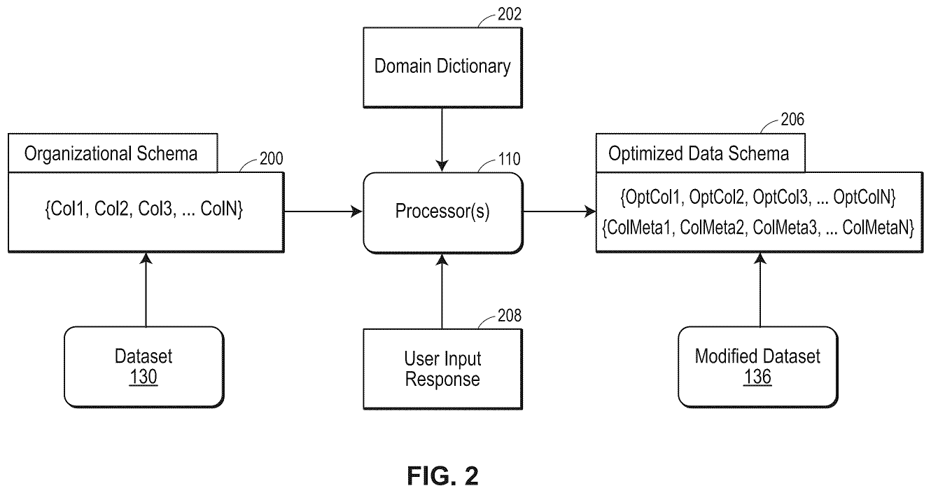

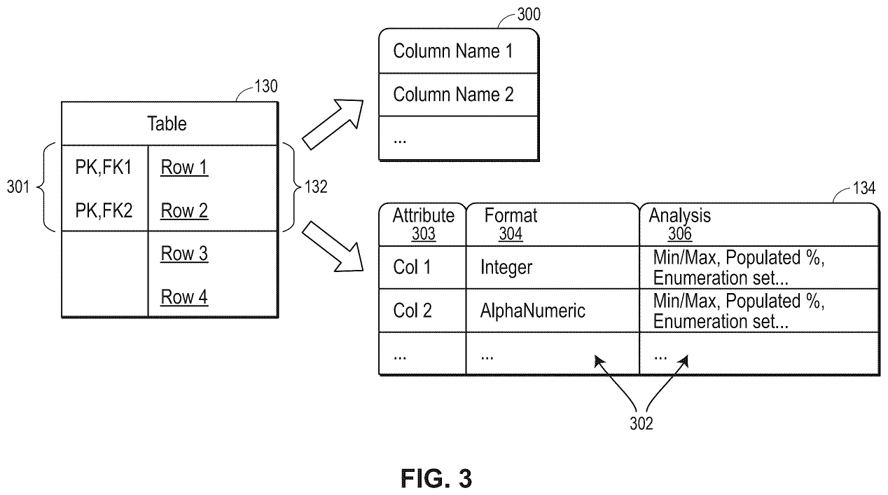

After receiving the dataset 130, the computing system 102, via the processor(s) 110, may extract or sample a subset 132 from the dataset 130 to generate a data insights matrix 134 and generate a modified dataset 136 from the dataset 130. As shown in FIG. 1B, the data insights matrix 134 and the modified dataset 136 may be used as inputs into the domain identification machine-learned model 116 and the dashboard selection component 118. Additional details on the data insights matrix 134 are described in connection with FIGS. 3 and 4 and additional details on the modified dataset 136 are described in connection with FIG. 2. In some embodiments, the modified dataset 136 may be omitted as an input to the domain identification machine-learned model 116 or the dashboard selection component 118. When executed by the processor(s) 110, the domain identification machine-learned model 116 generates a domain identifier 138 for the dataset 130.

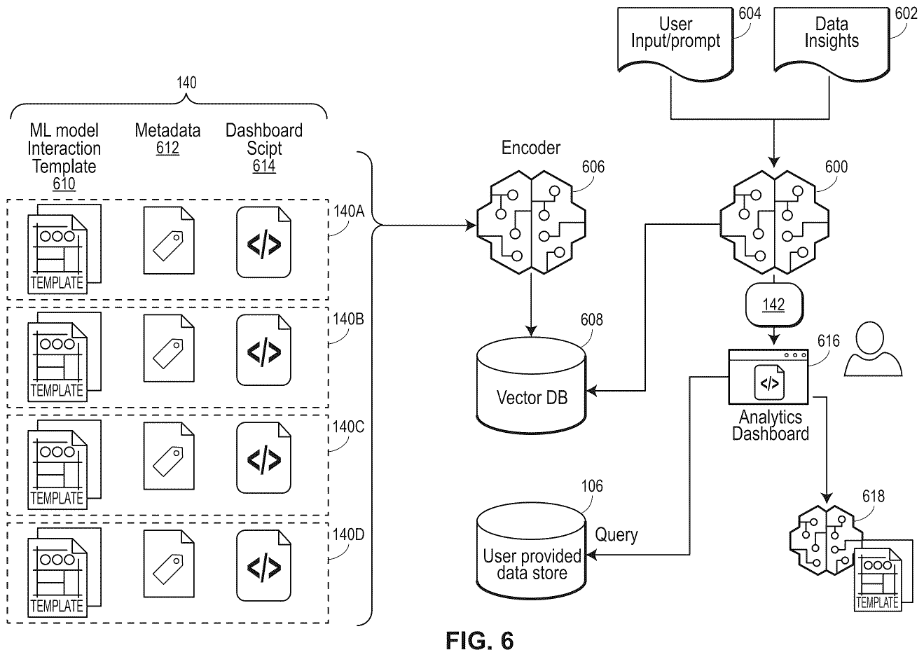

After the domain identification machine-learned model 116 generates the domain identifier 138, the computing system 102 may execute the dashboard selection component 118 to select an interactive data visualization dashboard from an encoded representation of dashboard options 140 based on the data visualization intent indication 131, the domain identifier 138, the data insights matrix 134, and the modified dataset 136. In some embodiments, the dashboard selection component 118 may execute a search or matching algorithm such as cosine similarity or other natural language processing techniques to select the interactive data visualization dashboard from among the dashboard options 140. For example, the dashboard selection component 118 may generate vector representations of the data insights matrix 134, the data visualization intent indication 131, and the domain identifier 138 and compare the vector representations using the search or matching algorithms to the encoded representation of dashboard options 140. The dashboard selection component 118 may then select the interactive data visualization dashboard based on the comparing, such as by selecting the closest matching option (e.g., highest cosine similarity value) of the dashboard options 140. Any suitable criteria for selecting the interactive data visualization dashboard based on the comparing may be used. Furthermore, in some embodiments, the dashboard selection component 118 may include a dashboard selection machine-learned model that the computing system 102 uses to select the interactive data visualization dashboard. More details on these embodiments are described below in connection with FIG. 6.

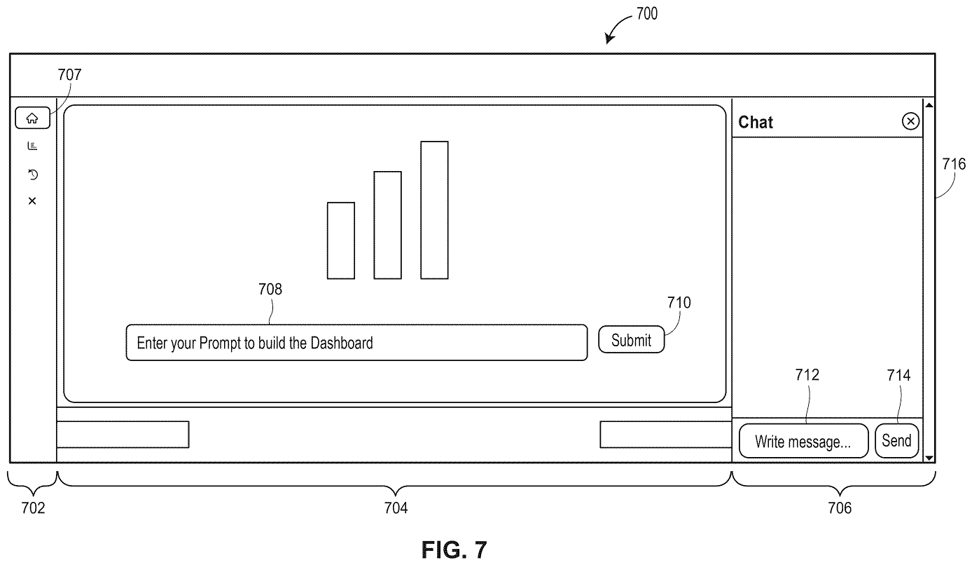

After selecting the appropriate interactive data visualization dashboard option, the computing system 102 may retrieve a dashboard code script 142 that is linked to the selected option and execute at least a portion of the code script 142 to present the interactive data visualization dashboard on the computing device 104. In some embodiments, the computing system 102 may transmit at least a portion of the dashboard code script 142 to the computing device 104 for execution by the processor(s) 120 so as to facilitate, at least in part, display of the interactive data visualization dashboard. In particular, execution of the dashboard code script 142 by the processor(s) 110 and/or 120 may cause the computing device 104 to display a first representation of the dataset 130 on the computing device 104. The first representation may include one or more visualizations included in the data visualization intent indication 131. Additional details on the display of the interactive data visualization dashboard are described below in connection with FIGS. 7-9.

FIG. 2 depicts an example process for generating the modified dataset 136 from the dataset 130 for use by the domain identification machine-learned model 116 and/or the dashboard selection component 118. First, the computing system 102 parses the dataset 130 to determine an organizational schema 200 of the dataset 130. The computing system 102 may then detect column labels from the dataset 130 and sample the data to detect, by a named entity recognition model, portions of the organizational schema 200 that correspond to contents of a domain dictionary 202. In some examples, a named entity recognition model indication (e.g., via a score that meets or exceeds a threshold score) that a dictionary term was detected may be used to augment the organizational schema 200 with metadata associated with the term and/or convert portions of the organizational schema 200 based at least in part on the domain dictionary 202 to generate an optimized or modified data schema 206.

In particular, the optimized or modified data schema 206 may comprise optimized or modified column values (e.g. OptCol1, OptCol2, OptCol3, . . . OptColN) and optimized or modified metadata (e.g., ColMeta1, ColMeta2, ColMeta3, . . . ColMetaN) for the columns. For example, the optimized or modified metadata for the columns may include revised data formats such as converting text material identified as a date in to a date specific data format. Furthermore, the optimized or modified column values may include different column headings or cell values such as converting plain text into number or data charterers appropriate for the optimized or modified metadata. The computing system 102 determines the optimized or modified column values and metadata based on the comparison between the organizational schema 200 and the domain dictionary 202. In some embodiments, the computing system 102 may request user input to confirm the optimized or modified data schema 206.

For example, the computing system 102 may transmit a description of the optimized or modified data schema 206 to the computing device 104 and receive a user input response 208. The user input response 208 may confirm or affirm that the optimized or modified data schema 206 is accurate, or reject the optimized or modified data schema 206 as incorrect or inaccurate. When the user input response 208 confirms the optimized or modified data schema 206 the computing system 102 may apply the optimized or modified data schema 206 to the dataset 130 to generate the modified dataset 136. However, when the user input response 208 rejects the optimized or modified data schema 206 the computing system 102 may refrain from applying the optimized or modified data schema 206 to the dataset 130. Furthermore, in this latter case, the computing system 102 may repeatedly generate or determine additional revised data schemas and request user inputs regrading theses additional revised data schemas until the user input response 208 includes a confirmation. In some embodiments, the computing system 102 may save the user input response 208 and the optimized or modified data schema 206 associated therewith to use as training data for custom ML models configured to generate future revised data schemas.

FIGS. 3 and 4 depict example processes for generating the data insights matrix 134. First, as shown in FIG. 3, the computing system 102 parses the dataset 130 to extract the subset 132. In particular, the subset 132 may include a random subset of rows from a tabular formatted version of the dataset 130. The computing system 102 may then filter each of the rows by the columns 300 for each of one, some, or all data entries in the subset 132. In some embodiments, the computing system 102 may utilize primary and foreign keys (e.g., PK, FK1, PK, FK2, etc.) to sample the subset 132 (e.g., row 1, row 2, but not row 3 and 4). Once filtered, the columns 300 may be subject to additional parsing and analysis by the computing system 102 to generate the data insights matrix 134. In particular, the computing system 102 may extract attributes and/or characteristics for each of one, some, or all entries in the subset 132 and based on the associated one of the columns 300 and relative to a preconfigured set of data context attributes to generate the data insights matrix 134 to documents features of the dataset 130 for every one of the columns 300 of the subset 132. The preconfigured set of data context attributes are described below in more detail.

In general, the data insights matrix 134 may include a structured table, array, matrix, or other structured/organized set of values that specifies features of the dataset 130 according to the preconfigured set of data context attributes. For example, the preconfigured set of data context attributes may describe specific statistical features, summaries, data attributes, etc. that the computing system 102 is tasked with determining for one, some, or all of the columns 300 that are filtered from the subset 132. In particular, the preconfigured set of data context attributes may include at least one of a minimum column value (e.g., the minimum value that occurs in an associated one of the columns 300), a maximum column value (e.g., the maximum value that occurs in an associated one of the columns 300), a column data format (e.g., the data format assigned to an associated one of the columns 300), a column size value (e.g., the number of entries in an associated one of the columns 300), a column average value (e.g., the average of the entries in an associated one of the columns 300), a column key value (e.g., a most often repeated entry in an associated one of the columns 300), a column increment amount (e.g., a difference between the maximum and minimum values in an associated one of the columns 300), or a column population percentage (e.g., a value indicating how populated an associated one of the columns 300 is such as 100%, 50%, etc.). However, it should be appreciated that other additional data context attributes are possible.

As shown in FIG. 3, the data insights matrix 134 may include a tabular data structure 302 that lists each of one, some, or all the columns 300 by an attribute name 303 (e.g., col. 1, col 2, etc.) in relation to an data format 304 (e.g., integer, alphanumeric, date, text, currency, etc.) of the subset 132 identified by the computing system 102 when parsing the columns 300. The data insights matrix 134 as shown in FIG. 3 may also include a data column for other analysis results 306 that the computing system 102 identified from the columns 300 based on additional ones of the preconfigured set of data context attributes. Furthermore, as shown in FIG. 4, the data insights matrix 134 may alternatively include a data grouping 400 that organizes the identified features of the subset 132 relative to the preconfigured set of data context attributes. In particular, the data grouping 400 may include an enumerated set 402 (e.g., a reproduction of the column values) of the subset 132 organized by the columns 300, a list of the minimum values 404 for each of one, some, or all of the columns 300, a list of the maximum values 406 for each of one, some, or all of the columns 300, a list of the data format 408 for each of one, some, or all of the columns 300, a list of column size values 410 for each of one, some, or all of the columns 300, and a list of column average value 412 for each of one, some, or all of the columns 300 of the samples. Additional features of the subset 132 that may be documented by the data insights matrix 134 include, but are not limited to a list of column key value for each of one, some, or all of the columns 300, a list of column increment amounts for each of one, some, or all of the columns 300, and/or a list of column population percentages for each of one, some, or all of the columns 300.

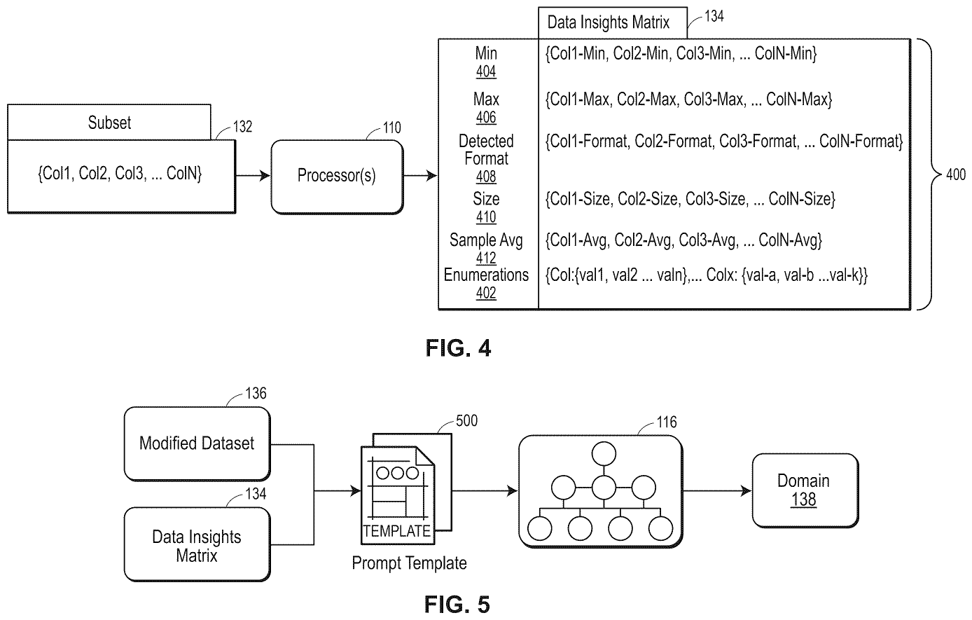

FIG. 5 depicts an example process for generating the domain identifier 138. Specifically, as shown in FIG. 5, the computing system 102 may insert at least a portion of the modified dataset 136 and the data insights matrix 134 into a prompt template 500 for the domain identification machine-learned model 116. The prompt template 500 may include rules, instructions, etc. that direct how the domain identification machine-learned model 116 processes the modified dataset 136 and the data insights matrix 134 to generate the domain identifier 138. As described above, the parameters of the domain identification machine-learned model 116 may be set during a training process. In some embodiments, the training data for the domain identification machine-learned model 116 may include sets of labeled domain data for different types of domains as well as variant of data for the same domain over time.

FIG. 6 depicts an example process for selecting the interactive data visualization dashboard, which incorporates a dashboard selection machine-learned model 600 as at least part of the dashboard selection component 118. As shown in FIG. 6, the dashboard selection machine-learned model 600 may receive data insights 602 and a prompt 604 as inputs. The data insights 602 may include at least a portion of the data insights matrix 134, the domain identifier 138, and/or the modified dataset 136 as described herein. The prompt 604 may include rules, instructions, etc. that direct how the dashboard selection machine-learned model 600 analyzes the data insights 602 to generate an output of the dashboard selection machine-learned model 600. The output of the dashboard selection machine-learned model 600 is used to select the interactive data visualization dashboard and recall the dashboard code script 142 for execution on the computing system 102 and/or computing device 104.

In some embodiments, the output of the dashboard selection machine-learned model 600 may include a dashboard template or another similar ML generated object that the computing system 102 can compare to encoded vector representations of the dashboard options 140 to select the interactive data visualization dashboard. The dashboard options may comprise a combination of software components and associated parameters that present different visualization features for the dataset 130 when executed. For example, the dashboard options may present visualization features that comprises at least one of a histogram, a plot, a decision tree, a feature reduction, or a Uniform Manifold Approximation and Projection (UMAP) of high-dimensional features into a two-dimensional space. Furthermore, the parameters for the code sets may include an axes, a type of error, a type of interpolation, data to dimension assignment (e.g., data A in first dimension, data B in second dimension), labels, etc.

In some embodiments, an encoder 606 may convert the dashboard options 140 into the encoded vector representations and store the encoded vector representations in a vector database 608. The encoder 606 may comprise a Bidirectional encoder representations from transformers (BERT) system, a Generative Pre-trained Transformer (e.g., GPT 3.5) system, a Word 2Vec system, etc. The encoded representations generated by the encoder 606 may comprise embeddings for a machine learned model such as the dashboard selection machine-learned model 600 and/or other machine-learned models described herein. Furthermore, in some embodiments, the encoder 606 or another similar encoder may generate and encoding or embedding of at least one of the data visualization intent indication 131, the domain identifier domain identifier 138, or the data insights matrix 134 (e.g., the data insights 602) for processing by the dashboard selection machine-learned model 600 and/or other machine-learned models described herein.

The vector database 608 may include the data store 106 or another similar data storage system or component that is in electronic communication with the computing system 102. To compare the dashboard template or another similar ML generated object with the encoded vector representations of the dashboard options 140, the computing system 102 may access the vector database 608 to recall the encoded vector representations and execute one of the search or matching algorithms described herein to select the interactive data visualization dashboard from among the encoded vector representations of the dashboard options 140.

In some embodiments, the output of the dashboard selection machine-learned model 600 may include an indicator of an interactive data visualization dashboard that is selected by the dashboard selection machine-learned model 600 from among the dashboard options 140. In these embodiments, the dashboard options 140 or the encoded vector representation thereof may also be input into the dashboard selection machine-learned model 600. The indicator of the interactive data visualization dashboard may include a memory location reference for the dashboard code script 142 that the computing system 102 uses to recall the dashboard code script 142 for execution. The indicator of the interactive data visualization dashboard may also include an indication to use or propose via a user interface of the computing device 104 at least one of a subset of parameters from among a set of parameters (e.g., the software components and associated parameters of the dashboard options 140) or the set of code scripts from among a superset of code scripts. In some embodiments, the indication is a score (e.g., a logit indicating a posterior probability determined by a machine-learned model) that meets or exceeds a threshold score. Furthermore, in some embodiments, the indicator of the interactive data visualization dashboard includes a list of the visualization features provided by the interactive data visualization dashboard.

In some embodiments, the computing system 102 may initially determine multiple potential data visualization dashboard options (e.g., output multiple options from the dashboard selection machine-learned model 600 or determine multiple matches to the generated dashboard template, etc.). In these embodiments, the computing system 102 may present a list of the identified potential dashboard options on the display device of the computing device 104 (e.g., a list of the software components and associated parameters of the dashboard options 140 and/or the visualization features provided thereby). The computing system 102 may then receive user input, via the computing device 104 and the I/O component(s) 124, that selects the interactive data visualization dashboard from the list of dashboard options. In some embodiments, the computing system 102 may save the interactive data visualization dashboard selected from the list to use as labeled training data for future ML models or to refine the dashboard selection machine-learned model 600.

As shown in FIG. 6, the dashboard options 140 may include a plurality of potential data visualization dashboards 140A-D. Each of one, some, or all of the potential data visualization dashboards 140A, 140B, 140C, 140N, etc. include a respective machine-learned model interaction template 610, a respective metadata template 612, and a respective dashboard code script 614. The respective dashboard code scripts 614, including the dashboard code script 142, may include program instructions that are executable by the computing system 102 and/or the computing device 104 to present different user interfaces of the potential data visualization dashboards 140A-D with arrangements of data therein indicated by the respective metadata template 612. In particular, the respective metadata template 612 for each of the potential data visualization dashboards 140A-D may include data that summarizes or describes particular use cases for which the potential data visualization dashboards 140A-D. For example, the respective metadata template 612 may include descriptors of the type of data the potential data visualization dashboards 140A-D is suited for (e.g., numerical data, text data, dates, etc.) and descriptors for the kinds of visualization that the dashboard is suited to produce (e.g., pie charts, bar graphs, kinds of statistical data analysis, etc.)

Once the computing system 102 selects the data visualization dashboard and recalls the associated dashboard code script 142, the computing system 102 and/or the computing device 104 may execute the dashboard code script 142 to present a first user interface 616 of the selected on the display device of the computing device 104. The first user interface 616 may include a first representation of at least a portion of the dataset 130 according to the data visualization intent indication 131. For example, the first representation may include a visual depiction (graphs, tables, icons, etc.) representing portions of the dataset 130, statistics generated from the dataset 130 (e.g., averages, maximums, minimums, etc.), and/or other visual depictions requested by the user of the computing device 104.

In some embodiments, the first representation may be generated by a generative machine learned model 618 that is input with relevant portions of the dataset 130 and the data visualization intent indication 131. The generative machine learned model 618 may be a specific model that is linked to the selected interactive data visualization dashboard by the respective machine-learned model interaction template 610 and accordingly represents a model the computing system 102 determined as well suited to generate the first representation. The generative machine learned model 618 may include a proprietary ML model trained on private data known to the computing system 102 and/or a publicly trained model operated by a third party provider. When the generative machine learned model 618 includes the third party provided model, the computing system 102 may be configured to interact with the model over the network 108 using an application programming interface for the third party model.

In some embodiments, the first user interface 616 may include one or more interactive user elements configured to enable the user of the computing device 104 to modify the first user interface 616 to display new visual representations of the dataset 130 and/or to modify the first visual representation. The interactive user element may include a text input field displayed on the first user interface, a component of a chat bot executed as a part of the interactive data visualization dashboard (e.g., a component for receiving user text, audio, or similar interactions with the chat bot), or a user-selectable graphical user interface element (e.g., a selectable graphic, a check box, a toggle button, etc.). For example, the interactive user element may enable the user of the computing device 104 to request a modified visual representation where new statistical summaries are generated or prior displayed summaries are removed to highlight different features of the dataset 130.

To facilitate generation of the modified or new visual representation, the computing device 104 may transmit an indication of user interaction with the interactive user element of the first user interface to the computing device 104. In response to receiving the indication, the computing system 102 may retrieve the respective machine-learned model interaction template 610 that is linked to the interactive data visualization dashboard and process the indication of the user interaction according to rules and instructions contained in the respective machine-learned model interaction template 610. In particular, the rules and instructions may direct the computing system 102 to query the data store 106 for additional or new portions of the dataset 130 used to generate the new or modified visual representation of the dataset 130. The computing system 102 may then pass the new or additional portions of the dataset 130 along with relevant instructions or commands to cause the generative machine learned model 618 to generate the modified or new visual representation.

In some embodiments, the computing system 102 may select a different ML model to generate the modified or new visual representation than the ML model that was selected to generate the first visual representation. Furthermore, in some embodiments, user interaction with the interactive user element may trigger the computing system 102 to select a new interactive data visualization dashboard and respective dashboard code script 614 from among the dashboard options 140 in a manner similar to that described above.

It should be appreciated that, in some embodiments, some or all of the process steps described above as being performed by the computing system 102 may instead be performed locally by the computing device 104.

### Example Interactive Data Visualization Dashboard

As described above, the interactive data visualization dashboard selected by the computing system 102 may be presented on a display device of the computing device 104. Furthermore, in some embodiments, the computing device 104 alone or in conjunction with the computing system 102 may present an interactive user interface environment. The interactive user interface environment may be configured to receive the user input that indicates the dataset 130 and the data visualization intent indication 131 (see FIGS. 1A and 1B) that initiates display of the interactive data visualization dashboard.

FIG. 7 depicts an example first user interface 700 for initiating display of an interactive data visualization dashboard as described herein. The first user interface 700 includes a navigation section 702, a first user interface section 704, and a chat bot interface section 706. In some embodiments, user selection of a home screen button 707 within the navigation section 702 triggers the computing device 104 to display the first user interface section 704.

As depicted in FIG. 7, the first user interface section 704 includes a text entry box 708 for receiving the user input related to the data visualization intent indication 131 (see FIG. 1B). and a submit button 710 to initiate transmission of the user input into the text entry box 708 to the computing system 102. In some embodiments, the first user interface section 704 may also include an interactive element for uploading the dataset 130 and/or for including an indication of the location of the dataset 130 within the data store 106 (FIG. 1A).

As depicted in FIG. 7, the chat bot interface section 706 may include another text entry box 712 for receiving chat bot text queries and a send button 714 for submitting the text quarries to the computing system 102 and/or the generative machine learned model 618 as described herein. A dialog window 716 may log the chat bot text queries and any responses.

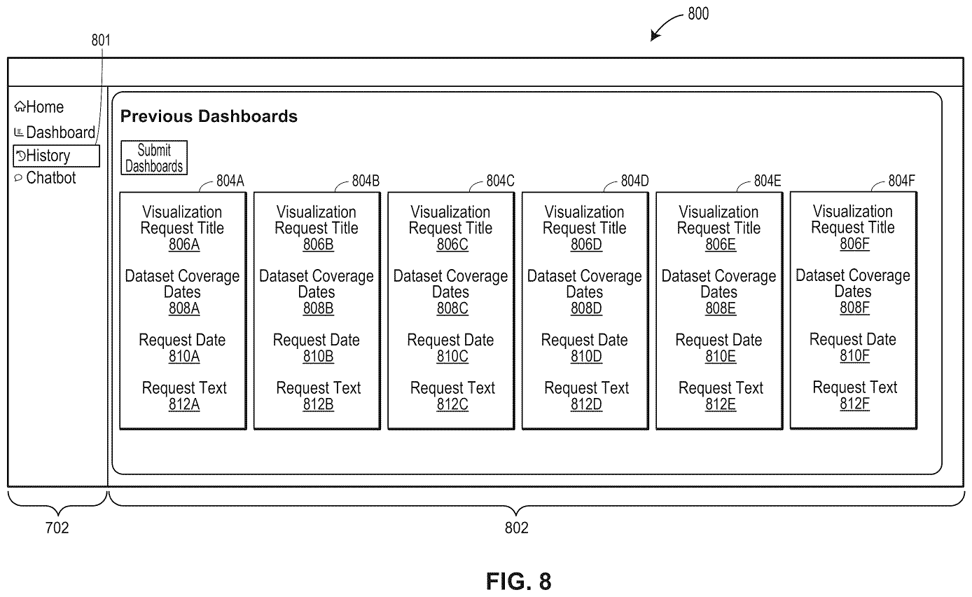

FIG. 8 depicts an example second user interface 800 for initiating display of an interactive data visualization dashboard as described herein. In particular, the second user interface 800 includes the navigation section 702 and a previous dashboard selection section 802. In some embodiments, user selection of a history button 801 within the navigation section 702 triggers the computing device 104 to display the previous dashboard selection section 802. The previous dashboard selection section 802 displays a plurality of historical dashboard prompts 804A, B, C, D, E, F that relate to previously requested data visualization intentions for prior datasets. It should be appreciated that the dashboard selection section 802 may include any other suitable number of historical prompts, such as more or fewer historical dashboard prompts than those shown in FIG. 8.

As shown in FIG. 8, the plurality of historical dashboard prompts 804A-F may include identifying details that indicate features of the historical dashboard prompts 804A-F. In particular, these identifying details may include Visualization Request Titles 806A-F that summarize the corresponding historical dashboard prompts 804AA-F. The identifying details may also include Dataset Coverage Dates 808 A-F that indicate a date range for the dataset used in connection with the corresponding historical dashboard prompts 804A-F. The identifying details may also include Request Dates 810A-F that indicate a date the corresponding historical dashboard prompts 804A-F was first made. The identifying details may also include request texts 812A-F that indicate the full text of the data visualization intent or request provided to the computing device 104 in connection with the historical dashboard prompts 804A-F. Example request text may include but is not limited to:
Give me graphs based on the totals of various subject matter metrics for a specific entity located in the central region. This data should be for data processed between Mar. 3, 2023, and Jan. 8, 2024, where the indicator field is set to “y”
or
Give me two line charts, 2 bar graphs, 2 pie charts, 8 key performance indicators (kpis), and filters based on the totals of various subject matter metrics from table A for a specific entity located in the central region. This data should be for data processed between Mar. 3, 2023, and Jan. 8, 2024, where the indicator field is set to “y”

User interaction with the historical dashboard prompts 804A-F may be configured to cause the computing device 104 and/or the computing system 102 to display an interactive data visualization dashboard consistent with the previously requested data visualization intentions for prior datasets. In some embodiments, the computing device 104 and/or the computing system 102 may save a previous end state of the previously initiated dashboards (e.g., the view state of the dashboard display when the user exits) and restore the previous end state when user interaction with the plurality of historical dashboard prompts 804A-F is detected. Furthermore, in some embodiments, the second user interface 800 may also include display of the chat bot interface section 706.

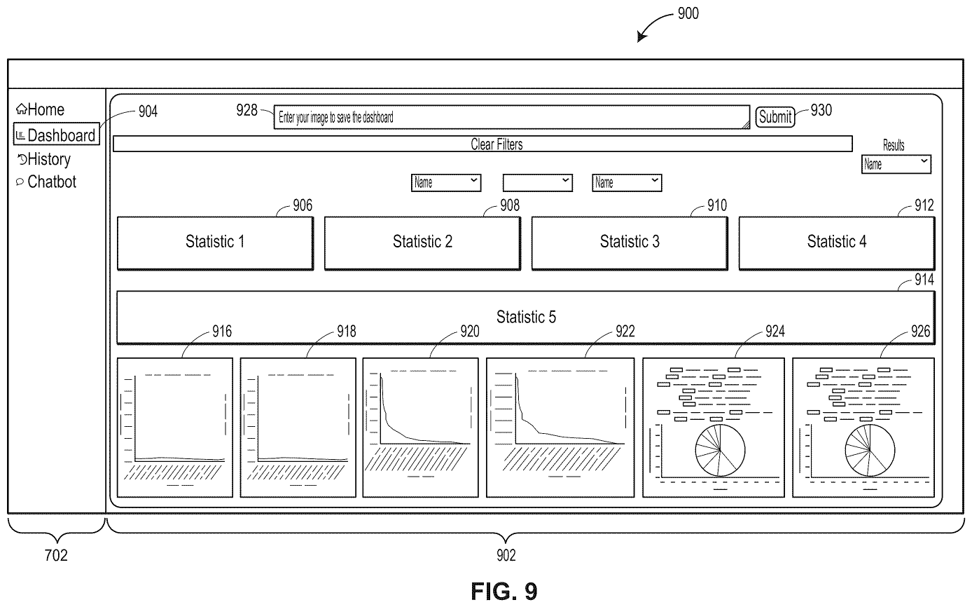

FIG. 9 depicts an example third user interface 900 that includes the navigation section 702 and one example interactive data visualization dashboard 902. In some embodiments, user selection of a dashboard button 904 within the navigation section 702 triggers the computing device 104 to display the interactive data visualization dashboard 902. The interactive data visualization dashboard 902 may also be automatically presented in response to interaction with the submit button 710 shown in FIG. 7.

As shown in FIG. 9, the interactive data visualization dashboard 902 may include data summary representations 906, 908, 910, 912, and 914 that display a summary of a particular element or statistic derived from the dataset 130. For example, the data summary representation 906 depicts a total amount of cases present in the dataset 130. The interactive data visualization dashboard 902 may also include graphical data representations 916, 918, 920, 922, 924, and 926 showing different features of the dataset 130 requested by the user of the computing device 104. The interactive data visualization dashboard 902 may also include a text entry box 928 for indicating changes to the interactive data visualization dashboard 902 and a submission button 930 for sending the entered text to the computing system 102 and/or the generative machine learned model 618 as described herein. Furthermore, in some embodiments, the third user interface 900 may also include display of the chat bot interface section 706 for triggering the modifications to the interactive data visualization dashboard 902 as described in more detail above.

### Example Computer-Implemented Method

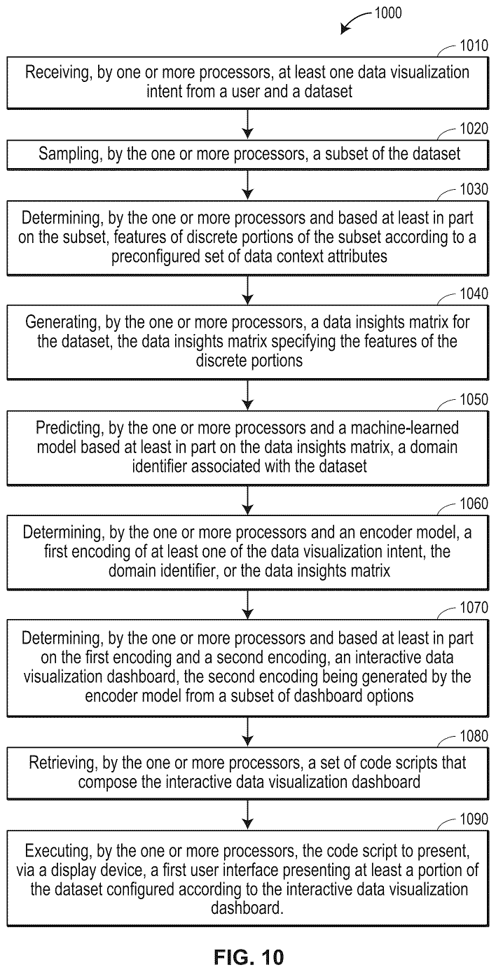

FIG. 10 depicts a flow diagram of an example computer-implemented method 1000 for selecting and presenting an interactive data visualization dashboard. The method 1000 may be implemented by processor-executable instructions stored in the memory 112 when executed by processor(s) 110, for example.

At operation 1010, the method 1000 comprises receiving, by one or more processors, at least one data visualization intent (e.g., the data visualization intent indication 131 of FIG. 1B) from a user and a dataset (e.g., the dataset 130 of FIG. 1B).

At operation 1020, the method 1000 comprises sampling, by the one or more processors, a subset (e.g., the subset 132 of FIG. 1B) of the dataset.

At operation 1030, the method 1000 comprises determining, by the one or more processors and based at least in part on the subset, features of discrete portions of the subset according to a preconfigured set of data context attributes (see e.g., the identified data format 304 and analysis results 306 of FIG. 3 and the data grouping 400 of FIG. 4).

At operation 1040, the method 1000 comprises generating, by the one or more processors, a data insights matrix (e.g., the data insights matrix 134 of FIG. 1B, 3, or 4) for the dataset. The data insights matrix specifies the features of the discrete portions.

At operation 1050, the method 1000 comprises predicting, by the one or more processors and a machine-learned model (e.g., the domain identification machine-learned model 116 of FIGS. 1A, 1B, and 5) based at least in part on the data insights matrix, a domain identifier (e.g., the domain identifier 138 of FIGS. 1B and 5) associated with the dataset.

At operation 1060, the method 1000 comprises determining, by the one or more processors and an encoder model (e.g., the encoder 606 of FIG. 6), a first encoding of at least one of the data visualization intent, the domain identifier, or the data insights matrix.

At operation 1070, the method 1000 comprises determining, by the one or more processors and based at least in part on the first encoding and a second encoding, an interactive data visualization dashboard. The second encoding is generated by the encoder model from a subset of dashboard options (e.g., the dashboard options 140 of FIGS. 1B and 6).

At operation 1080, the method 1000 comprises retrieving, by the one or more processors, a set of code scripts (e.g., the dashboard code script 142 of FIG. 1B) that compose the interactive data visualization dashboard.

At operation 1090, the method 1000 comprises executing, by the one or more processors, the code script to present, via a display device, a first user interface (e.g., the third user interface 900 of FIG. 9) presenting at least a portion of the dataset configured according to the interactive data visualization dashboard.

It is to be understood that the operations of the method 1000 may be performed in any suitable order (and/or in parallel), and/or may include fewer, additional, or different operations, in various embodiments.

### EXAMPLES

Example 1. A system comprising: one or more processors; and at least one memory storing processor-executable instructions that, when executed by the one or more processors, cause the one or more processors to perform operations comprising: receiving at least one data visualization intent from a user and a dataset; sampling a subset of the dataset; determining, based at least in part on the subset, features of discrete portions of the subset according to a preconfigured set of data context attributes; generating a data insights matrix for the dataset, the data insights matrix specifying the features of the discrete portions; predicting, by a machine-learned model based at least in part on the data insights matrix, a domain identifier associated with the dataset; determining, by an encoder model, a first encoding of at least one of the data visualization intent, the domain identifier, or the data insights matrix; determining, based at least in part on the first encoding and a second encoding, an interactive data visualization dashboard, the second encoding being generated by the encoder model from a subset of dashboard options; retrieving a set of code scripts that compose the interactive data visualization dashboard; and executing the code script to present, via a display device, a first user interface presenting at least a portion of the dataset configured according to the interactive data visualization dashboard, the portion indicating at least a portion of the dataset that is not within the subset.

Example 2. The system of example 1, wherein the operations further comprise: receiving a user interaction with an interactive user element of the first user interface; retrieving a machine-learned model interaction template that is linked to the interactive data visualization dashboard; generating, by the machine-learned model and based at least in part on the machine-learned model interaction template and the user interaction, a second user interface of the interactive data visualization dashboard, the second user interface being different from the first user interface; and presenting, via the display device, the second user interface.

Example 3. The system of example 2, wherein the interactive user element includes at least one of a text input field displayed on the first user interface, a component of a chat bot executed as a part of the interactive data visualization dashboard, or a user-selectable graphical user interface element.

Example 4. The system of example 1, wherein the operations further comprise: detecting an organizational schema of the dataset; comparing the organizational schema to a domain dictionary; determining a modified schema to apply to the dataset based on a result of the comparing; and altering the dataset according to the modified schema to generate a modified dataset, wherein predicting the domain identifier by the machine-learned model is further based at least in part on the modified dataset.

Example 5. The system of example 4, wherein the operations further comprise: comparing the organizational schema to the domain dictionary via a named entity recognition model.

Example 6. The system of example 1, wherein the subset of dashboard options comprise a combination of software components and associated parameters that present different visualization features for the dataset when executed, and wherein determining the interactive data visualization dashboard based at least in part on the first encoding and the second encoding comprises: determining at least one of the combination of software components and associated parameters that provide at least one data visualization feature consistent with the at least one data visualization intent.

Example 7. The system of example 6, wherein the different visualization features comprises at least one of a histogram, plot, a decision tree, a feature reduction, or a UMAP projection of high-dimensional features into a two-dimensional space.

Example 8. The system of example 1, wherein determining the interactive data visualization dashboard includes: generating, by a dashboard selection machine-learned model and based at least in part on the first encoding and the second encoding, an indicator of the interactive data visualization dashboard.

Example 9. The system of example 8, wherein the indicator of the interactive data visualization dashboard comprises at least one of: a memory location reference for the set of code scripts; or an indication to use or propose via a user interface at least one of a subset of parameters from among a set of parameters or the set of code scripts from among a superset of code scripts, the indication comprising a score that meets or exceeds a threshold score.

Example 10. The system of example 8, wherein the indicator of the interactive data visualization dashboard includes a list of candidate dashboard options that present different visualization features for the dataset when executed, and wherein selecting the interactive data visualization dashboard further includes: receiving user input selecting a subset of the candidate dashboard options as the interactive data visualization dashboard.

Example 11. The system of example 1, wherein the operations further comprise: generating, by a dashboard selection machine-learned model and based at least in part on the data insights matrix, the data visualization intent, and the domain identifier, a dashboard template, wherein the first encoding is generated based at least in part on the dashboard template; determining, based at least in part on distances between the first encoding and third encodings generated by the encoder model for a set of dashboard options, a subset of dashboard options; and determining the interactive data visualization dashboard using the dashboard template and the subset of dashboard options.

Example 12. The system of example 1, wherein the preconfigured set of data context attributes includes at least one of a minimum column value, a maximum column value, a column data format, a column size value, a column average value, a column key value, a column increment amount, or a column population percentage.

Example 13. The system of example 12, wherein the data insights matrix comprises at least one of: an enumerated set of the samples organized by column number; a list of the minimum values for each of one, some, or all columns of the samples; a list of the maximum values for each of one, some, or all columns of the samples; a list of the data format for each of one, some, or all columns of the samples; a list of column size values for each of one, some, or all columns of the samples; a list of column average value for each of one, some, or all columns of the samples; a list of column key value for each of one, some, or all columns of the samples; a list of column increment amounts for each of one, some, or all columns of the samples; and a list of column population percentages for each of one, some, or all columns of the samples.

Example 14. A computer-implemented method comprising: receiving, by one or more processors, at least one data visualization intent from a user and a dataset; sampling, by the one or more processors, a subset of the dataset; determining, by the one or more processors and based at least in part on the subset, features of discrete portions of the subset according to a preconfigured set of data context attributes; generating, by the one or more processors, a data insights matrix for the dataset, the data insights matrix specifying the features of the discrete portions; predicting, by the one or more processors and a machine-learned model based at least in part on the data insights matrix, a domain identifier associated with the dataset; determining, by the one or more processors and an encoder model, a first encoding of at least one of the data visualization intent, the domain identifier, or the data insights matrix; determining, by the one or more processors and based at least in part on the first encoding and a second encoding, an interactive data visualization dashboard, the second encoding being generated by the encoder model from a subset of dashboard options; retrieving, by the one or more processors, a set of code scripts that compose the interactive data visualization dashboard; and executing, by the one or more processors, the code script to present, via a display device, a first user interface presenting at least a portion of the dataset configured according to the interactive data visualization dashboard.

Example 15. The computer-implemented method of example 14 further comprising: receiving, by the one or more processors, a user interaction with an interactive user element of the first user interface; retrieving, by the one or more processors, a machine-learned model interaction template that is linked to the interactive data visualization dashboard; generating, by the one or more processors and the machine-learned model and based at least in part on the machine-learned model interaction template and the user interaction, a second user interface of the interactive data visualization dashboard, the second user interface being different from the first user interface; and presenting, by the one or more processors and via the display device, the second user interface.

Example 16. The computer-implemented method of example 14 further comprising: detecting, by the one or more processors, an organizational schema of the dataset; comparing, by the one or more processors, the organizational schema to a domain dictionary; determining, by the one or more processors, a modified schema to apply to the dataset based on a result of the comparing; altering, by the one or more processors, the dataset according to the modified schema to generate a modified dataset, wherein predicting the domain identifier by the machine-learned model is further based at least in part on the modified dataset.

Example 17. The computer-implemented method of example 16 further comprising: requesting, by the one or more processors, user input confirming the modified schema.

Example 18. The computer-implemented method of example 14 wherein selecting the interactive data visualization dashboard includes: generating, via the one or more processors, by a dashboard selection machine-learned model and based at least in part on the first encoding and the second encoding, an indicator of the interactive data visualization dashboard.

Example 19. The computer-implemented method of example 14 further comprising: generating, by the one or more processors and a dashboard selection machine-learned model and based at least in part on the data insights matrix, the data visualization intent, and the domain identifier, a dashboard template, wherein the first encoding is generated based at least in part on the dashboard template; determining, by the one or more processors and based at least in part on distances between the first encoding and third encodings generated by the encoder model for a set of dashboard options, a subset of dashboard options; and determining, by the one or more processors, the interactive data visualization dashboard using the dashboard template and the subset of dashboard options.

Example 20. One or more non-transitory computer-readable media storing processor-executable instructions that, when executed by one or more processors, cause the one or more processors to perform operations comprising: receiving at least one data visualization intent from a user and a dataset; sampling a subset of the dataset; determining, based at least in part on the subset, features of discrete portions of the subset according to a preconfigured set of data context attributes; generating a data insights matrix for the dataset, the data insights matrix specifying the features of the discrete portions; predicting, by a machine-learned model based at least in part on the data insights matrix, a domain identifier associated with the dataset; determining, by an encoder model, a first encoding of at least one of the data visualization intent, the domain identifier, or the data insights matrix; determining, based at least in part on the first encoding and a second encoding, an interactive data visualization dashboard, the second encoding being generated by the encoder model from a subset of dashboard options; retrieving a set of code scripts that compose the interactive data visualization dashboard; and executing the code script to present, via a display device, a first user interface presenting at least a portion of the dataset configured according to the interactive data visualization dashboard.

### ADDITIONAL CONSIDERATIONS

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A system comprising:
one or more processors; and
at least one memory storing processor-executable instructions that, when executed by the one or more processors, cause the one or more processors to perform operations comprising:
receiving at least one data visualization intent from a user and a dataset;
sampling a subset of the dataset;
determining, based at least in part on the subset, features of discrete portions of the subset according to a preconfigured set of data context attributes;
generating a data insights matrix for the dataset, the data insights matrix specifying the features of the discrete portions;
predicting, by a machine-learned model based at least in part on the data insights matrix, a domain identifier associated with the dataset;
determining, by an encoder model, a first encoding of at least one of the data visualization intent, the domain identifier, or the data insights matrix;
determining, based at least in part on the first encoding and a second encoding, an interactive data visualization dashboard, the second encoding being generated by the encoder model from a subset of dashboard options;
retrieving a set of code scripts that compose the interactive data visualization dashboard; and
executing the code script to present, via a display device, a first user interface presenting at least a portion of the dataset configured according to the interactive data visualization dashboard, the portion indicating at least a portion of the dataset that is not within the subset.

2. The system of claim 1, wherein the operations further comprise:
receiving a user interaction with an interactive user element of the first user interface;
retrieving a machine-learned model interaction template that is linked to the interactive data visualization dashboard;
generating, by the machine-learned model and based at least in part on the machine-learned model interaction template and the user interaction, a second user interface of the interactive data visualization dashboard, the second user interface being different from the first user interface; and
presenting, via the display device, the second user interface.

3. The system of claim 2, wherein the interactive user element includes at least one of a text input field displayed on the first user interface, a component of a chat bot executed as a part of the interactive data visualization dashboard, or a user-selectable graphical user interface element.

4. The system of claim 1, wherein the operations further comprise:
detecting an organizational schema of the dataset;
comparing the organizational schema to a domain dictionary;
determining a modified schema to apply to the dataset based on a result of the comparing; and
altering the dataset according to the modified schema to generate a modified dataset,
wherein predicting the domain identifier by the machine-learned model is further based at least in part on the modified dataset.

5. The system of claim 4, wherein the operations further comprise:
comparing the organizational schema to the domain dictionary via a named entity recognition model.

6. The system of claim 1, wherein the subset of dashboard options comprises a combination of software components and associated parameters that present different visualization features for the dataset when executed, and wherein determining the interactive data visualization dashboard based at least in part on the first encoding and the second encoding comprises:
determining at least one of the combination of software components and associated parameters that provide at least one data visualization feature consistent with the at least one data visualization intent.

7. The system of claim 6, wherein the different visualization features comprises at least one of a histogram, a plot, a decision tree, a feature reduction, or a UMAP projection of high-dimensional features into a two-dimensional space.

8. The system of claim 1, wherein determining the interactive data visualization dashboard includes:
generating, by a dashboard selection machine-learned model and based at least in part on the first encoding and the second encoding, an indicator of the interactive data visualization dashboard.

9. The system of claim 8, wherein the indicator of the interactive data visualization dashboard comprises at least one of:
a memory location reference for the set of code scripts; or
an indication to use or propose via a user interface at least one of a subset of parameters from among a set of parameters or the set of code scripts from among a superset of code scripts, the indication comprising a score that meets or exceeds a threshold score.

10. The system of claim 8, wherein the indicator of the interactive data visualization dashboard includes a list of candidate dashboard options that present different visualization features for the dataset when executed, and wherein selecting the interactive data visualization dashboard further includes:
receiving user input selecting a subset of the candidate dashboard options as the interactive data visualization dashboard.

11. The system of claim 1, wherein the operations further comprise:
generating, by a dashboard selection machine-learned model and based at least in part on the data insights matrix, the data visualization intent, and the domain identifier, a dashboard template, wherein the first encoding is generated based at least in part on the dashboard template;
determining, based at least in part on distances between the first encoding and third encodings generated by the encoder model for a set of dashboard options, a subset of dashboard options; and
determining the interactive data visualization dashboard using the dashboard template and the subset of dashboard options.

12. The system of claim 1, wherein the preconfigured set of data context attributes includes at least one of a minimum column value, a maximum column value, a column data format, a column size value, a column average value, a column key value, a column increment amount, or a column population percentage.

13. The system of claim 12, wherein the data insights matrix comprises at least one of:
an enumerated set of the samples organized by column number;
a list of the minimum values for each of one, some, or all columns of the samples;
a list of the maximum values for each of one, some, or all columns of the samples;
a list of the data format for each of one, some, or all columns of the samples;
a list of column size values for each of one, some, or all columns of the samples;
a list of column average value for each of one, some, or all columns of the samples;
a list of column key value for each of one, some, or all columns of the samples;
a list of column increment amounts for each of one, some, or all columns of the samples; and
a list of column population percentages for each of one, some, or all columns of the samples.

14. A computer-implemented method comprising:
receiving, by one or more processors, at least one data visualization intent from a user and a dataset;
sampling, by the one or more processors, a subset of the dataset;
determining, by the one or more processors and based at least in part on the subset, features of discrete portions of the subset according to a preconfigured set of data context attributes;
generating, by the one or more processors, a data insights matrix for the dataset, the data insights matrix specifying the features of the discrete portions;
predicting, by the one or more processors and a machine-learned model based at least in part on the data insights matrix, a domain identifier associated with the dataset;
determining, by the one or more processors and an encoder model, a first encoding of at least one of the data visualization intent, the domain identifier, or the data insights matrix;
determining, by the one or more processors and based at least in part on the first encoding and a second encoding, an interactive data visualization dashboard, the second encoding being generated by the encoder model from a subset of dashboard options;
retrieving, by the one or more processors, a set of code scripts that compose the interactive data visualization dashboard; and
executing, by the one or more processors, the code script to present, via a display device, a first user interface presenting at least a portion of the dataset configured according to the interactive data visualization dashboard.

15. The computer-implemented method of claim 14 further comprising:
receiving, by the one or more processors, a user interaction with an interactive user element of the first user interface;
retrieving, by the one or more processors, a machine-learned model interaction template that is linked to the interactive data visualization dashboard;
generating, by the one or more processors and the machine-learned model and based at least in part on the machine-learned model interaction template and the user interaction, a second user interface of the interactive data visualization dashboard, the second user interface being different from the first user interface; and
presenting, by the one or more processors and via the display device, the second user interface.

16. The computer-implemented method of claim 14 further comprising:
detecting, by the one or more processors, an organizational schema of the dataset;
comparing, by the one or more processors, the organizational schema to a domain dictionary;
determining, by the one or more processors, a modified schema to apply to the dataset based on a result of the comparing;
altering, by the one or more processors, the dataset according to the modified schema to generate a modified dataset,
wherein predicting the domain identifier by the machine-learned model is further based at least in part on the modified dataset.

17. The computer-implemented method of claim 16 further comprising:
requesting, by the one or more processors, user input confirming the modified schema.

18. The computer-implemented method of claim 14 wherein selecting the interactive data visualization dashboard includes:
generating, via the one or more processors, by a dashboard selection machine-learned model and based at least in part on the first encoding and the second encoding, an indicator of the interactive data visualization dashboard.

19. The computer-implemented method of claim 14 further comprising:
generating, by the one or more processors and a dashboard selection machine-learned model and based at least in part on the data insights matrix, the data visualization intent, and the domain identifier, a dashboard template, wherein the first encoding is generated based at least in part on the dashboard template;
determining, by the one or more processors and based at least in part on distances between the first encoding and third encodings generated by the encoder model for a set of dashboard options, a subset of dashboard options; and
determining, by the one or more processors, the interactive data visualization dashboard using the dashboard template and the subset of dashboard options.

20. One or more non-transitory computer-readable media storing processor-executable instructions that, when executed by one or more processors, cause the one or more processors to perform operations comprising:
receiving at least one data visualization intent from a user and a dataset;
sampling a subset of the dataset;
determining, based at least in part on the subset, features of discrete portions of the subset according to a preconfigured set of data context attributes;
generating a data insights matrix for the dataset, the data insights matrix specifying the features of the discrete portions;
predicting, by a machine-learned model based at least in part on the data insights matrix, a domain identifier associated with the dataset;
determining, by an encoder model, a first encoding of at least one of the data visualization intent, the domain identifier, or the data insights matrix;
determining, based at least in part on the first encoding and a second encoding, an interactive data visualization dashboard, the second encoding being generated by the encoder model from a subset of dashboard options;
retrieving a set of code scripts that compose the interactive data visualization dashboard; and
executing the code script to present, via a display device, a first user interface presenting at least a portion of the dataset configured according to the interactive data visualization dashboard.
